(19) United States
(12) Patent Application Publication
(10) Pub. No.: US 2007/0199654 A1
(43) Pub. Date: Aug. 30, 2007

(54) LAYERED PLASTIC NETTING

(75) Inventors: Bartley J. Kohel, Oakdale, MN (US); Chris E. Worthington, St. Paul, MN (US); Andrew J. Thoen, Harris, MN (US)

Correspondence Address: BROOKS KUSHMAN P.C., 1000 TOWN CENTER, TWENTY-SECOND FLOOR, SOUTHFIELD, MI, 48075, US

(73) Assignee: CONWED PLASTICS LLC, Minneapolis, MN (US)

(21) Appl. No.: 11/678,829

(22) Filed: Feb. 26, 2007

Related U.S. Application Data
(60) Provisional application No. 60/777,089, filed on Feb. 27, 2006.

(51) Int. Cl. B32B 37/00

(52) U.S. Cl. 156/308.2; 428/212

(57) ABSTRACT

One embodiment of the present invention provides a layered plastic netting. The netting can include a first outer layer comprised of a first polymeric material, an inner layer comprised of a second polymeric material, and a second outer layer generally opposed to the first outer layer and comprised of a third polymeric material. The first polymeric material can be comprised of first relatively low melt temperature (LMP) polymeric material. The second polymeric material can be comprised of a relatively high melt temperature (HMP) polymeric material. The third polymeric material can be comprised of a second relatively LMP polymeric material differing from the first relatively LMP polymeric material.

### CROSS-REFERENCE TO RELATED APPLICATIONS

This application claims the benefit of U.S. provisional application Ser. No. 60/777,089 filed Feb. 27, 2006, which is incorporated herein by reference.

### BACKGROUND

1. Technical Field

One aspect of the present invention relates to a layered plastic netting.

2. Background Art

The process of continuous extrusion of plastic netting was introduced in the 1950s. Extruded netting includes strands extruded from a die and netting joints that can be formed either within the die or immediately outside the die. A variety of configurations are known, such as square, diamond, twill, etc. Some of the more common materials used to prepare extruded netting are polypropylene, polyethylene (for example linear low grades, and ethylene copolymers), nylon, polybutylene, and blends thereof.

Currently, one typical extrusion process for manufacturing plastic nets includes extruding plastic strands in an interconnecting network to provide a net-like structure. Typically, either a rotary or a reciprocating extrusion process is employed. Methods for practicing the reciprocating technique are well known. For instance, U.S. Pat. Nos. 3,700,521, 3,767,353, 3,723,218, 4,123,491, 4,152,479 and 4,190,692 each provide an apparatus and method for making nets by the continuous extrusion of individual plastic strands. These patents are herein incorporated by reference in their entirety.

Extrusion technology has been developed and utilized to make plastic netting with two or three resin polymer layers of two different materials. According to one extrusion process, two molten polymer resins are fed to a single extrusion die. While in the extrusion die, the molten polymer resins remain substantially separated, with minimal mixing, but travel through and exit the extrusion die as a single resin mass having two distinct phases or resin layers.

According to one technology, the exit passage of the extrusion die includes reciprocating strikers and raised and spaced lands. For instance, U.S. Pat. Nos. 4,190,692, 4,656,075 and 4,755,247 each provide such a die and methods of use. These patents are herein incorporated by reference in their entirety. This technology can be utilized to form netting with integral joints and cross direction strands traverse to machine direction strands, which is commonly referred to as “coextruded” netting. Conwed Plastics LLC, of Minneapolis, Minn., employs this technology to manufacture plastic netting sold under the trade name Thermanet® Thermal Adhesive Netting.

As discussed above, coextruded plastic netting has been manufactured with first and second polymer resin layers. According to one technology, the first polymer layer is a relatively high melting point (HMP) polymer, such as polypropylene (PP) or linear low density polyethylene (LLDPE), and the second polymer layer is a relatively low melting point (LMP) polymer, such as ethylene vinyl acetate copolymer (EVA), ethylene methyl acrylate copolymer (EMA), or polypropylene-polyethylene copolymer (PP-PE). In certain applications, the two layer plastic netting can be adhesively bonded to a single substrate. The LMP polymer layer acts as an adhesive layer for bonding the plastic netting to the substrate. The LMP polymer layer can be applied in a melted state to the substrate through a process of thermal lamination. As the LMP polymer layer cools, it forms an adhesive bond with the substrate.

The two layer plastic netting discussed above has been further modified to yield a three layer netting. The HMP polymer layer can be sandwiched between two layers of the same LMP polymer. This allows the three layer netting to be sandwiched between two substrate layers with similar bonding characteristics, thermal resistance properties, etc. Disadvantageously, this structure is not well suited for adhesively bonding two opposing substrates of differing materials with different bonding characteristics because while one substrate material may form a strong bond with the LMP polymer, the other substrate material may form a weak bond with the same LMP polymer.

In light of the foregoing, it would be advantageous to provide a layered plastic netting configuration specifically tailored for being adhesively bonded and sandwiched between two substrate layers of differing materials. Such a configuration is needed to allow composites involving two substrate materials with different physical and bonding characteristics, e.g., surface topology, chemical composition, thermal degradation characteristics, etc. It would also be beneficial to provide a process for adhesively bonding the two different substrate layers to the netting structure that reduces the possibility of damaging the two substrate materials.

### SUMMARY

According to one embodiment of the present invention, a layered plastic netting is disclosed. The netting is specifically tailored for being adhesively bonded and sandwiched between two substrate layers of differing materials. According to at least one aspect, the netting allows substrate-netting composites involving two substrate materials with different physical and bonding characteristics, e.g., surface topology, chemical composition, thermal degradation characteristics, etc. Another embodiment of the present invention is a process for adhesively bonding two substrate layers of differing materials to a layered plastic netting that reduces the possibility of damaging the two substrate materials.

Yet another feature of this invention is the enhancement of bond strength in substrate-netting composites. This feature provides improved bond strength between substrates and a netting layer through tailored adhesive properties and material compatibility.

According to one embodiment of the present invention, a layered plastic netting is provided. The netting includes a first outer layer comprised of a first polymeric material, an inner layer comprised of a second polymeric material, and a second outer layer generally opposed to the first outer layer and comprised of a third polymeric material. The first polymeric material is comprised of a first relatively low melt temperature (LMP) polymeric material. The second polymeric material is comprised of a relatively high melt temperature (HMP) polymeric material. The third polymeric material is comprised of a second relatively LMP polymeric material differing from the first relatively LMP polymeric material.

The layered plastic netting can be a network of intersecting extruded polymeric strands. The first and second outer layers can be bonded to the inner core layer by fusion adhesion and coextrusion of the strands.

The HMP polymeric material can be polypropylene. The first LMP polymeric material can be ethylene vinyl acetate copolymer (EVA). The second LMP polymeric material can be polypropylene-polyethylene copolymer (PP-PE). In certain aspects, the HMP polymeric material is PP, the first LMP polymeric material is EVA, and the second LMP polymeric material is PP-PE.

The layered plastic netting can be comprised of substantially equal weight percentages of the HMP polymeric material, the first LMP polymeric material and the second LMP polymeric material.

The layered plastic netting can be comprised of 2 to 30 weight % of the first LMP polymeric material, 40 to 96 weight % of the HMP polymeric material, and 2 to 30 weight % of the second LMP polymeric material.

The first LMP polymeric material, the second LMP polymeric material, andor the HMP polymeric material can include one or more additives or polymer blends.

In at least one embodiment, a netting-substrate composite material is provided. The layered plastic netting includes a first outer layer comprised of a first polymeric material, an inner layer comprised of a second polymeric material, and a second outer layer generally opposed to the first outer layer and comprised of a third polymeric material. The first polymeric material is comprised of a first relatively low melt temperature (LMP) polymeric material. The second polymeric material is comprised of a relatively high melt temperature (HMP) polymeric material. The third polymeric material is comprised of a second relatively LMP polymeric material differing from the first relatively LMP polymeric material. The netting-substrate composite material further includes a first substrate adhesively bonded to the first LMP polymeric material and a second substrate disposed oppositely from the first substrate and adhesively bonded to the second LMP polymeric material.

The netting-substrate composite can include a layered plastic netting that is a network of intersecting extruded polymeric strands. The first and second outer layers can be bonded to the inner core layer by fusion adhesion and coextrusion of the strands.

With respect to this netting-substrate composite, the HMP polymeric material can be polypropylene. The first LMP polymeric material can be ethylene vinyl acetate copolymer (EVA). The second LMP polymeric material can be polypropylene-polyethylene copolymer (PP-PE). In certain aspects, the HMP polymeric material is PP, the first LMP polymeric material is EVA, and the second LMP polymeric material is PP-PE.

The first and second substrate materials can be different. The first substrate material can be comprised of a membrane. The second substrate material can be comprised of a nonwoven material.

In another embodiment of the present invention, a method for adhesively bonding a plastic netting to a first substrate and a second substrate to obtain a netting-substrate composite is provided. The method includes providing a layered plastic netting. The layered netting includes a first outer layer comprised of a first polymeric material, an inner layer comprised of a second polymeric material, and a second outer layer generally opposed to the first outer layer and comprised of a third polymeric material. The first polymeric material is comprised of a first relatively low melt temperature (LMP) polymeric material. The second polymeric material is comprised of a relatively high melt temperature (HMP) polymeric material. The third polymeric material is comprised of a second relatively LMP polymeric material differing from the first relatively LMP polymeric material.

The method further includes providing a first substrate comprised of a first substrate material and a second substrate comprised of a second substrate material, adhesively bonding the first LMP polymeric material to the first substrate, and adhesively bonding the second LMP polymeric material to the second substrate.

The method can further comprise selecting the first LMP material and the first substrate material based on the ability of the two materials to form a relatively strong adhesive bond.

The method can further comprise selecting the second LMP material and the second substrate material based on the ability of the two materials to form a relatively strong adhesive bond.

The first adhesive bonding step can be accomplished through a lamination process. The second adhesive bonding step can be accomplished through a lamination process. The lamination process can be comprised of a thermal lamination process.

### BRIEF DESCRIPTION OF THE DRAWINGS

FIG. 1 is a perspective view of a layered plastic netting according to one embodiment of the present invention;

FIG. 2 is a fragmented, sectional view taken along line 2-2 of FIG. 1;

FIG. 3 is a pictorial view of the layered plastic netting of FIG. 1 bonded to a first and second substrate according to one embodiment of the present invention; and

FIG. 4 is a fragmented, sectional view taken along line 4-4 of FIG. 3.

### DETAILED DESCRIPTION OF EMBODIMENTS OF THE PRESENT INVENTION

Reference will now be made in detail to presently preferred compositions, embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention or claims andor as a representative basis for teaching one skilled in the art to variously employ the present invention.

Except in the examples, or where otherwise expressly indicated, all numerical quantities in this description indicating amounts of material or conditions of reaction andor use are to be understood as modified by the word “about” in describing the broadest scope of the invention. Practice within the numerical limits stated is generally preferred. Also, unless expressly stated to the contrary: percent, “parts of,” and ratio values are by weight; the term “polymer” includes “oligomer,” “copolymer,” “terpolymer,” and the like; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

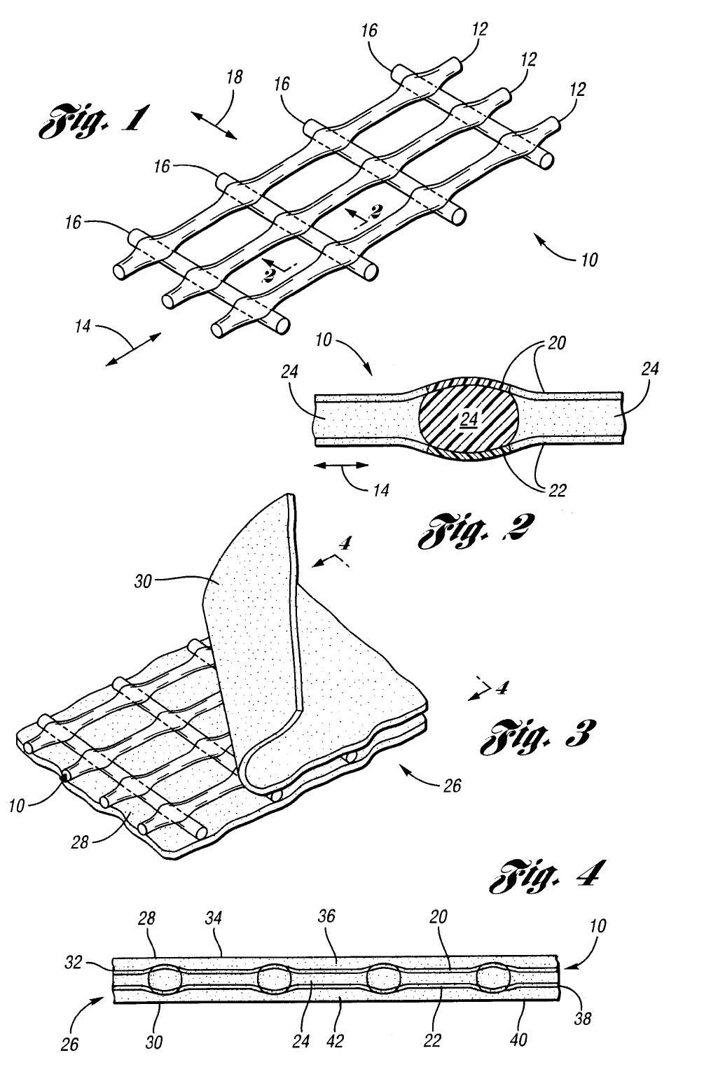

Referring to FIG. 1, a perspective view of an exemplary layered plastic netting 10 is illustrated. Netting 10 includes strands 12 extending in a first direction 14 and strands 16 extending in a second direction 18. As depicted in FIG. 1, the second direction 18 extends in a generally crosswise or transverse direction relative to the first direction 14. Although the embodiment depicted in FIG. 1 portrays a substantially rectangular netting configuration, it should be appreciated that the principles of this invention can be applied to other netting configuration shapes, such as square, rhombus, trapezoid and parallelogram.

Any suitable polymer coextrusion process can be utilized to make the layered plastic netting 10. Such processes are well known in the art. U.S. Pat. Nos. 4,656,075, 4,190,692 and 4,755,247 each disclose an exemplary process suitable for making the netting 10. These patents are herein incorporated by reference in their entirety.

According to one coextrusion process disclosed in these patents, molten resin materials are fed through an annular coextrusion die having reciprocating strikers for producing a tubular net-like structure having the general configuration of netting 10. The tubular net-like structure is then slit in the machine direction to form a layered coextruded netting with machine direction strands and cross direction strands. As applied to FIG. 1, first direction 14 is the machine direction and second direction 18 is the cross direction, therefore, strands 12 are the machine direction strands and strands 16 are the cross direction strands.

In at least one embodiment, the coextruded netting is then uniaxially oriented, i.e., oriented in only one direction, by any suitable uniaxial orienting process. For instance, the coextruded netting can be stretched in a single direction using a speed differential between two pairs of nip rollers. In other embodiments, the coextruded netting can be stretched in the cross direction only using a tenter frame. In yet other embodiments, the coextruded netting is biaxially oriented, i.e., oriented in both the machine and cross directions.

In at least one embodiment, the layered plastic netting 10 has machine direction strands per inch of 0.1 to 40, in other embodiments 0.25 to 20 strands per inch, and in yet other embodiments 0.5 to 15 strands per inch. In certain embodiments, the layered plastic netting 10 has machine direction strands per inch of 20.

In at least one embodiment, the layered plastic netting 10 has a cross direction strands per inch of 0.1 to 30, in other embodiments 0.25 to 15 strands per inch, and in yet other embodiments 0.5 to 10 strands per inch. In certain embodiments, the layered plastic netting 10 has cross direction strands per inch of 20.

Turning to FIG. 2, a fragmented, sectional view of layered plastic netting 10 taken along line 2-2 of FIG. 1 is illustrated. Layered plastic netting 10 includes a first outer layer 20, an opposing second outer layer 22 and an inner core layer 24.

Each of the layers 20, 22 and 24 is comprised of a different polymer resin to provide three layered plastic netting 10. For example, the first outer layer 20 can be comprised of a first lower melting point (LMP) polymer, the second outer layer 22 can be comprised of a second LMP polymer differing from the first LMP polymer and the inner core layer 24 can be comprised of a higher melting point (HMP) polymer. As used herein, this layered plastic netting configuration can otherwise be referred to as the LMP1-HMP-LMP2 netting configuration. Suitable LMP polymers include, without limitation, polyolefins, polyamides, polycarbonates, polyesters and copolymers thereof. Specific non-limiting examples of LMP polymers include ethylene vinyl acetate copolymer (EVA), ethylene methyl acrylate copolymer (EMA), low melt temperature polyethylene, urethanes and polypropylene-polyethylene copolymer (PP-PE). Non-limiting examples of HMP polymers include polyolefin resins, for example, polypropylene (PP), high density polyethylene (HDPE), low density polyethylene (LDPE), linear low density polyethylene (LLDPE), as well as polyamides, polycarbonates, polyesters and copolymers thereof. It should be appreciated that the classification of a polymer as an LMP or HMP polymer is relative. For example, a polymer can be made to function as an LMP polymer in an LMP1-HMP-LMP2 netting configuration if the bonding of the LMP polymer to a substrate at a melt temperature does not substantially negatively affect the structural integrity of the HMP polymer used therein.

Any or all of the three layers, LMP1, HMP or LMP2, may contain a biologically or oxidatively degradable polymer materials. Non-limiting examples of suitable degradable polymeric materials can be found in U.S. Pub. Pat. App. Nos. 2005/0183329 and 2005/0217173, which are herein incorporated by reference in their entirety.

The melt temperature can refer to any temperature wherein the resin begins to melt. It should be appreciated that a mechanical bond can be created between a resin and a substrate without the resin reaching its melt temperature. Indeed, the resin does not necessarily need to melt to adhere to a substrate. Instead, the resin temperature can be elevated so that the resin reaches a tackified state, so that adhesion between the resin and substrate can take place. This elevated temperature can be referred to as the adhesion temperature.

In certain embodiments, a lamination process can be used to mechanically bond the resin and substrate. Such lamination processes are well known in the art. For instance, a thermal lamination technique can be utilized. One thermal lamination technique includes contacting the resin and substrate at the adhesion temperature, e.g., the lamination temperature, to achieve bonding.

In at least one embodiment, substantially equal weight percentages (% s) of the LMP1, HMP and LMP2 materials comprise the LMP1-HMP-LMP2 netting structure. In at least another embodiment, the netting may comprise 2 to 30 weight % LMP1, 40 to 96 weight % HMP, and 2 to 30 weight % LMP2. In at least another embodiment, the netting may comprise 10 to 15 weight % LMP1, 60 to 80 weight % HMP, and 10 to 15 weight % LMP2. In yet another embodiment, the netting may comprise 12 to 18 weight % LMP1, 64 to 76 weight % HMP and 12 to 18 weight % LMP2, wherein LMP1 is EVA, HMP is PP and LMP2 is PP-PE copolymer.

In at least certain embodiments, the LMP1-HMP-LMP2 netting structure provides an exceedingly flexible and robust system for adhesively bonding plastic netting to substrates. In certain embodiments, plastic netting is sandwiched and adhesively bonded between first and second substrates, each comprised of different materials, to form a netting/substrate composite. In at least one embodiment, the first and second LMP polymers can be selected based on the ability of the polymers to form a relatively strong mechanical bond with a substrate material. In many instances, an LMP polymer that achieves a superior bond with one substrate material may form an inferior bond with a different substrate material. Advantageously, embodiments of the present invention recognize the use of a second LMP polymer specifically tailored to create a superior bond to a substrate material that differs from the opposing substrate material.

It should be appreciated that each substrate material used in the netting/substrate composite may be subject to alteration of physical and/or chemical properties when exposed to elevated temperatures. For a given material, this can be referred to as the degradation temperature. In at least one embodiment, the first substrate material has a first degradation temperature and the second substrate material has a second degradation temperature. In addition, a first adhesion temperature exists for bonding the first LMP polymer to the first substrate material and a second adhesion temperature exists for bonding the second LMP polymer to the second substrate material.

Advantageously, the LMP polymers and substrate materials can be selected so that the first adhesion temperature does not exceed the first degradation temperature and the second adhesion temperature does not exceed the second degradation temperature. In certain embodiments, the first degradation temperature is greater than the second degradation temperature. In such cases, the second substrate material is more sensitive to heat than the first substrate material. This sensitivity to heat can be taken into account during thermal lamination of the substrates to the netting. One representative thermal lamination process includes the use of a thermal lamination line, which typically include first and second opposing heated rollers. A gap of suitable thickness exists between the rollers such that the layers of the composite can be fed therethrough. The layers of the substrate-netting composite are brought together prior to being fed into the gap between the rollers. Each substrate is in contact with one of the heated rollers, thereby effectuating the bond to the netting. Advantageously, the heated rollers can be set at different temperatures to protect the more sensitive substrate. For instance, the second heated roller, which is in contact with the second substrate, can be set at a lower temperature relative to the first heated roller, which is in contact with the first substrate.

In at least one embodiment, the present invention is especially suitable for thermal lamination of plastic netting to opposing substrates since the LMP1-HMP-LMP2 netting configurations enables the first and second outer adhesive layers to bond to the opposing substrates at their respective lamination temperatures. Advantageously, thermal lamination of the opposing substrates can be accomplished at temperatures that do not thermally degrade or significantly alter the physical properties of the HMP inner layer.

Turning to FIG. 3, a pictorial representation of a netting-substrate composite 26 is disclosed. As depicted in FIGS. 3 and 4, netting-substrate composite 26 is comprised of first substrate 28, layered plastic netting 10 and second substrate 30. First substrate 28 includes an interface surface 32 for bonding to first outer layer 20 and an opposing outer surface 34. First substrate 28 also includes an inner portion 36. Second substrate 30 includes an interface surface 38 for bonding to second outer layer 22 and an opposing outer surface 40. Second substrate 30 includes an inner portion 42.

Non-limiting examples of substrate materials include vapor permeable membranes and vapor impermeable membranes. It should be appreciated that the substrate material can be comprised of one or more layers of material. Examples of vapor impermeable membranes include films or sheets of PP, PE or polyvinyl chloride (PVC). An example of a vapor permeable membrane is a breathable sheet material made of spunbonded synthetic fibers, such as polyethylene, polypropylene or polyester fibers, sheets of spunbonded-melt-blown-spunbonded (SMS) polymer fibers, perforated polymer films, woven slit film, microporous film laminates and breathable monolithic films. In at least certain embodiments, the vapor permeable membrane can comprise Tyvek® Homewrap, available from DuPont of Wilmington, Del. or Typar® Housewrap, available from BBA Fiberweb of London, England. Tyvek® is a single component material, i.e. flash spun PE, while Typar® is a two component material, i.e. spunbond PP, with an extrusion coating, put on in a different step. Both materials are water resistant, breathable sheet materials.

In at least one embodiment, layered plastic netting 10 can be used in the preparation of a composite building wrap. The netting can include a drainage channel for serving a water management function. In at least one embodiment, strands that are oriented in the vertical direction relative to the building foundation can have an average thickness that is 1.25 to 25 times the average thickness of the horizontal strands, thereby helping to form a water drainage channel. The vertical strands can have an average thickness of 4 to 290 mils, in other embodiments, an average thickness of 10 to 175 mils or an average thickness of 15 to 100 mils in yet other embodiments. The horizontal strands can have an average thickness of 0.5 to 50 mils, in other embodiments, an average thickness of 0.75 to 15 mils, or an average thickness of 1 to 10 mils in yet other embodiments. The composite building wrap can also include a nonwoven substrate layer for protecting the drainage channel from filling with unwanted material, such as stucco base coat in a stucco wall construction.

The embodiment depicted in FIGS. 3 and 4 can be utilized as a composite building wrap. First outer layer 20 is comprised of EVA, second outer layer 22 is comprised of PP-PE copolymer, and inner layer 24 is comprised of PP. The first substrate 28 is comprised of Typar® Housewrap, with an interface surface 32 comprised of a microporous coating, and an inner portion 36 and opposing surface 34 comprised of spunbond PP nonwoven. The EVA first outer layer 20 produces a relatively strong adhesive bond with the microporous coating interface surface 32. In addition to effectuating a relatively stronger bond to the microporous coating, the adhesion temperature of EVA is below the degradation temperature of the microporous coating. The second substrate 30 is comprised of nonwoven material. In at least one embodiment, spunbond PP nonwoven can be used as the nonwoven material. Whereas EVA produces a merely average bond to the spunbond PP nonwoven material, the present invention recognizes that PP-PE copolymer produces a relatively strong bond to the spunbond PP nonwoven material. Therefore, the PP-PE second outer layer 22 is adhesively bonded to the spunbond PP nonwoven material at the interface surface 38. In at least one embodiment, the netting 10 includes 12 to 18 weight % LMP1 (EVA), 64 to 76 weight % HMP (PP) and 12 to 18 weight % LMP2 (PP-PE copolymer).

It should be appreciated that any suitable adhesion process, such as thermal lamination, can be used to bond layered plastic netting 10 to the substrates 28 and 30. In at least one embodiment, the layered plastic netting 10 is oriented in the machine direction before the lamination process. It should be appreciated that the second substrate 30 can be comprised of any nonwoven materials and other materials as well.

In other embodiments, the present invention includes various LMP1-HMP-LMP2 layered combinations in which each layer is a unique, substantially homogeneous blend of one or more polymer resins (and optionally one or more additives). Examples of suitable additives include, but are not necessarily limited to, colorants, heat stabilizers, photo (UV) light stabilizers, photo (UV) light degraders, degradation additives, and flame retardants.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A layered plastic netting comprising:
a first outer layer comprised of a first polymeric material;
an inner layer comprised of a second polymeric material; and
a second outer layer generally opposed to the first outer layer and comprised of a third polymeric material,
the first polymeric material comprised of first relatively low melt temperature (LMP) polymeric material, the second polymeric material comprised of a relatively high melt temperature (HMP) polymeric material, and the third polymeric material comprised of a second relatively LMP polymeric material differing from the first relatively LMP polymeric material.

2. The layered plastic netting of claim 1, wherein the layered plastic netting is a network of intersecting extruded polymeric strands.

3. The layered plastic netting of claim 2, wherein the first and second outer layers are bonded to the inner core layer by fusion adhesion.

4. The layered plastic netting of claim 1, wherein the HMP polymeric material is polypropylene.

5. The layered plastic netting of claim 1, wherein the first LMP polymeric material is ethylene vinyl acetate copolymer (EVA).

6. The layered plastic netting of claim 1, wherein the second LMP polymeric material is polypropylene-polyethylene copolymer (PP-PE).

7. The layered plastic netting of claim 1, wherein the HMP polymeric material is PP, the first LMP polymeric material is EVA, and second LMP polymeric material is PP-PE.

8. The layered plastic netting of claim 1, wherein the layered plastic netting is comprised of 10 to 15 weight % of the first LMP polymeric material, 60 to 80 weight % of the HMP polymeric material, and 10 to 15 weight % of the second LMP polymeric material.

9. The layered plastic netting of claim 1, wherein the layered plastic netting is comprised of substantially equal weight percentages of the HMP polymeric material, the first LMP polymeric material and the second LMP polymeric material.

10. A netting-substrate composite material comprising:
a layered plastic netting comprising:
a first outer layer comprised of a first polymeric material;
an inner layer comprised of a second polymeric material; and
a second outer layer generally opposed to the first outer layer and comprised of a third polymeric material, the first polymeric material comprised of first relatively low melt temperature (LMP) polymeric material, the second polymeric material comprised of a relatively high melt temperature (HMP) polymeric material, and the third polymeric material comprised of a second relatively LMP polymeric material differing from the first relatively LMP polymeric material;
a first substrate adhesively bonded to the first LMP polymeric material; and
a second substrate disposed oppositedly from the first substrate and adhesively bonded to the second LMP polymeric material.

11. The netting-substrate composite of claim 10, wherein the layered plastic netting is a network of intersecting extruded polymeric strands.

12. The netting-substrate composite of claim 11, wherein the first and second outer layers are bonded to the inner core layer by fusion adhesion and coextrusion of the strands.

13. The netting-substrate composite of claim 10, wherein the HMP polymeric material is polypropylene.

14. The netting-substrate composite of claim 10, wherein the first LMP polymeric material is ethylene vinyl acetate copolymer (EVA).

15. The netting-substrate composite of claim 10, wherein the second LMP polymeric material is polypropylene-polyethylene copolymer (PP-PE).

16. The netting-substrate composite of claim 10, wherein the HMP polymeric material is PP, the first LMP polymeric material is EVA, and second LMP polymeric material is PP-PE.

17. The netting-substrate composite of claim 10, wherein the first and second substrate materials are different.

18. The netting-substrate composite of claim 10, wherein the first substrate material is comprised of a microporous membrane.

19. The netting-substrate composite of claim 18, wherein the second substrate material is comprised of a spunbound nonwoven material.

20. A method for adhesively boding a plastic netting to a first substrate and a second substrate to obtain a netting-substrate composite, the method comprising:
providing a layered plastic netting comprising:
a first outer layer comprised of a first polymeric material; an inner layer comprised of a second polymeric material; and
a second outer layer generally opposed to the first outer layer and comprised of a third polymeric material,
the first polymeric material comprised of first relatively low melt temperature (LMP) polymeric material, the second polymeric material comprised of a relatively high melt temperature (HMP) polymeric material, and the third polymeric material comprised of a second relatively LMP polymeric material differing from the first relatively LMP polymeric material;
providing a first substrate comprised of a first substrate material and a second substrate comprised of a second substrate material;
adhesively bonding the first LMP polymeric material to the first substrate; and
adhesively bonding the second LMP polymeric material to the second substrate.

21. The method of claim 20, further comprising selecting the first LMP material and the first substrate material based on the ability of the two materials to form a relatively strong adhesive bond to each other.

22. The method of claim 20, further comprising selecting the second LMP material and the second substrate material based on the ability of the two materials to form a relatively strong adhesive bond to each other.

23. The method of claim 20, wherein the first adhesively bonding step is accomplished through a lamination process.

24. The method of claim 20, wherein the second adhesively bonding step is accomplished through a lamination process.

25. The method of claim 23, wherein the lamination process is comprised of a thermal lamination process.

26. The method of claim 24, wherein the lamination process is comprised of a thermal lamination process.
